(19) United States
(12) Patent Application Publication
(10) Pub. No.: US 2025/0005333 A1
(43) Pub. Date: Jan. 2, 2025

(54) MACHINE LEARNING TO REDUCE RESOURCES FOR GENERATING SOLUTIONS TO MULTI-NODE PROBLEMS

(71) Applicant: Oracle International Corporation, Redwood Shores, CA (US)

(72) Inventors: Afshin Oroojlooyjadid, Hellertown, PA (US); Amir Hossein Rezaeian, San Mateo, CA (US)

(73) Assignee: Oracle International Corporation, Redwood Shores, CA (US)

(21) Appl. No.: 18/343,292

(22) Filed: Jun. 28, 2023

(51) Int. Cl. G06N 3/047

(52) U.S. Cl. CPC G06N 3/047

(57) ABSTRACT

In an embodiment, a method may include accessing, by a computing system, a multi-node problem. The multi-node problem may include a plurality of nodes, each respective node having one or more node features. The method may include providing, by the computing system, each respective node with each respective node feature to a machine learning model. The method may include determining, by the computing system using the machine learning model, a subset of nodes of the plurality of nodes based at least in part on the respective node features. The method may include calculating, by the computing system, one or more solutions to the multi-node problem based at least in part on the subset of nodes. The method may include storing, by the computing system, the one or more solutions to the multi-node problem in a computer memory.

### BACKGROUND

This disclosure relates generally to increased efficiency in performing resource-intensive computations. More specifically, this disclosure relates to generating solutions to multi-node problems.

### BRIEF SUMMARY

In an embodiment, a method may include accessing, by a computing system, a multi-node problem. The multi-node problem may include a plurality of nodes, each respective node having one or more node features. The method may include providing, by the computing system, each respective node with each respective node feature to a machine learning model. The method may include determining, by the computing system using the machine learning model, a subset of nodes of the plurality of nodes based at least in part on the respective node features. The method may include calculating, by the computing system, one or more solutions to the multi-node problem based at least in part on the subset of nodes. The method may include storing, by the computing system, the one or more solutions to the multi-node problem in a computer memory.

In some embodiments, the subset of nodes of the plurality of nodes may include non-zero nodes. In some embodiments, providing each respective node and each respective node feature may further include generating an embedded vector may include one or more dimensions corresponding to each respective node feature.

In some embodiments, determining the subset of nodes further may include determining, by the computing system using the machine learning model, a minimum value associated with each of the plurality of nodes. Determining the subset may further include determining, by the computing system using the machine learning model, a probability that the minimum value associated with each of the plurality of nodes is a value associated with each node in an optimal solution. Determining the subset may also include identifying, by the computing system, the subset of nodes, each node of the subset of nodes identified as non-zero and characterized by a probability greater than or equal to a predetermined threshold.

In some embodiments, the machine learning model may include a graph neural network. The multi-node problem may represent a multi-echelon inventory optimization problem. In some embodiments, the computer system may utilize a guaranteed service model to calculate the one or more solutions to the multi-node problem. The machine learning model may be trained at least in part on a historical dataset may include a plurality of solutions to multi-node problems. In some embodiments, the one or more solutions to the multi-node problem may be provided to a second computing system.

In an embodiment, a computing system may include one or more processors. The computing system may also include a non-transitory computer readable medium may include instructions that, when executed by the one or more processors, cause the computing system to perform operations. The operations may cause the computing system to access a multi-node problem. The multi-node problem may include a plurality of nodes, each respective node having one or more node features. The computing system may then provide each respective node with each respective node feature to a machine learning model. The computing system may then determine, using the machine learning model, a subset of nodes of the plurality of nodes based at least in part on the respective node features. The computing system may then calculate one or more solutions to the multi-node problem based at least in part on the subset of nodes. The computing system may store the one or more solutions to the multi-node problem in a computer memory.

In some embodiments, the machine learning model includes an embedding module. The subset of nodes of the plurality of nodes may include non-zero nodes. The multi-node problem may represent a multi-echelon inventory optimization problem. The computing system may utilize a guaranteed service model to calculating the one or more solutions to the multi-node problem. In some embodiments, the historical dataset may include a plurality of solutions to multi-node problems.

In an embodiment, a non-transitory computer-readable storage medium may store a set of instructions. The instructions, when executed by one or more processors of a computing system, may cause the computing system to perform operations. The operations may include accessing, by a computing system, a multi-node problem. The multi-node problem may include a plurality of nodes, each respective node having one or more node features. The operations may include providing, by the computing system, each respective node with each respective node feature to a machine learning model. The operations may include determining, by the computing system using the machine learning model, a subset of nodes of the plurality of nodes based at least in part on the respective node features. The operations may include calculating, by the computing system, one or more solutions to the multi-node problem based at least in part on the subset of nodes. The operations may include storing, by the computing system, the one or more solutions to the multi-node problem in a computer memory.

In some embodiments, the subset of nodes of the plurality of nodes may include non-zero nodes. Determining the subset of nodes may further include determining, by the computing system using the machine learning model, a minimum value associated with each of the plurality of nodes. Determining the subset of nodes may also include determining, by the computing system using the machine learning model, a probability that the minimum value associated with each of the plurality of nodes is a value associated with each node in an optimal solution. Determining the subset of nodes may also include identifying, by the computing system, the subset of nodes, each node of the subset of nodes identified as non-zero and characterized by a probability greater than or equal to a predetermined threshold. In some embodiments, the computer system may utilize a guaranteed service model to calculate the one or more solutions to the multi-node problem. The machine learning model may include an embedding module.

### BRIEF DESCRIPTION OF THE DRAWINGS

FIG. 1 illustrates a simplified diagram of a logistics chain, according to certain embodiments.

FIG. 2 illustrates a simplified multi-node problem, according to certain embodiments.

FIG. 3 illustrates a system and a process for identifying zero-nodes, according to certain embodiments.

FIG. 4 illustrates a system for identifying a subset of nodes, according to certain embodiments.

FIG. 5 illustrates a flowchart of a method for generating solutions to a multi-node problem, according to certain embodiments.

FIG. 6 is a block diagram illustrating one pattern for implementing a cloud infrastructure as a service system, according to at least one embodiment.

FIG. 7 is a block diagram illustrating another pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating an example computer system, according to at least one embodiment.

### DETAILED DESCRIPTION

The ability to collect and perform calculations on large data sets has provided opportunities to address previously impossible or impractical to solve problems. The larger the datasets, the more computationally expensive a problem may be to find solutions. As the world grows more complex, datasets representing real-world issues grow in size. Managing these datasets may pose issues in themselves; collecting, sorting, and storing ever-growing datasets may pose significant challenges. Performing computations on these datasets may pose even more significant challenges.

Certain classes of problems (e.g., NP-hard problems) are notoriously hard to solve. Even simple, scaled down versions of these problems may be practically unsolvable due to restraints on processor speeds, availability of processing power, time, energy, and other issues. As NP hard problems grow in size, the complexity (and therefore computational resources needed to generate solutions) of these problems may grow exponentially. Unfortunately, many real world problems that may be NP hard problems. While solving them may be beneficial, techniques to more efficiently generate solutions may be needed first.

An example of such real world NP hard problems may be found in modern supply chains. Supply chains and related logistical issues grow more complicated with each passing year, as the number of products offered expands and the size of the supply chain grows. Computer-generated solutions may be used to address logistics chain problems. However, the growing complexity of logistics chains have associated problems that may require so much time, energy, and/or computing power, that solving these problems is impractical. Even with the ever-increasing availability of computing power, both in individual processors and in cloud computing, there are still logistics problems that require weeks, months, or longer to solve.

These logistics problems may be represented by a multi-node problem, such as a multi-echelon inventory optimization problem (MEIO). The MEIO problem represents a supply chain as a network of nodes. Each node may be associated with a location within the supply chain (e.g., a supplier, a warehouse, an outlet, etc.) and an inventory item. A value associated with the node may represent a quantity of the inventory item at the location. Each node may also include one or more decision variables (or “node features”). The node features may include a number of successor nodes, a number of predecessor nodes, a distance to the source, a demand mean, a demand variance, a lead time mean, a lead time variance, a local hold cost, a service level ratio, and other such variables.

One method of solving these problems may be the Guaranteed Service Model algorithm (GSM). The GSM algorithm may provide the optimal solution for an MEIO problem, but the GSM still requires large amounts of computing power and time to solve even relatively small MEIO problems. The complexity of MEIO problems may grow exponentially as the number of nodes increases linearly. The computing power and/or time needed to solve these problems also may grow exponentially with the complexity of these problems. For example, a small problem with 50 nodes, running the GSM algorithm, may take a few hours to solve. A problem with 500 nodes, however, may take more than 10 days to solve. Modern supply chain networks may have thousands of nodes, however. For example, for a very small network of one warehouse and 10 retailers that only provides 100 items would have a network of 1100 nodes. Running the GSM for just a few iterations on even a small network like this would be very time consuming; solving the MEIO may take tens of thousands of iterations and therefore large amounts of time, energy, and/or computing power.

Because the complexity of the MEIO problem increases exponentially with a linear increase in the number of nodes, decreasing the number of nodes in the problem may reduce the complexity and reduce the time and computing power needed to generate a solution. To reduce the number nodes, nodes may be removed from the MEIO problem. As a node corresponds to an inventory item per location, there may be two ways to remove a node from the MEIO problem. The first way may be to remove the location. However, removing a location from a supply chain may be impractical or impossible.

In an optimized solution to an MEIO problem, however, not all nodes may be non-zero. For example, in the optimized solution, some locations may hold zero counts of an inventory item while still meeting demand throughout the logistics chain. These locations and zero-item pairs may be zero-nodes. Solving the GSM for the MEIO problem would provide the zero-nodes (and non-zero nodes), but as previously discussed, may require large amounts of time, energy, and computing power. Therefore, a technique is needed to identify zero and non-zero nodes in an optimized solution to an MEIO problem without solving the MEIO problem first.

In an embodiment, one or more machine learning models (MLM) may be used to identify the zero- and/or non-zero nodes. For example, a graph neural network (GNN) and/or a transformer may be employed in a single MLM. The MLM may then be trained using optimized solutions to MEIO problems, solved using the GSM algorithm. In at least some of the solved MEIO problems, one or more nodes may be zero-nodes. The MLM may be trained to identify zero- and non-zero nodes included in an MEIO problem, based at least in part on node features of each node.

When a new MEIO problem is created, perhaps representing a logistics chain each node in the MEIO problem may be characterized by associated node features. Then, each node may be analyzed by the MLM, determining an importance of each node to its neighbors, each node's effect on other nodes in the logistics chain, a minimal inventory level (or value), and a probability. The probability may represent the probability that the minimal inventory level determined by the MLM is the same inventory that would appear for that node in the optimized solution.

Once the MLM has analyzed every node, the probability of each node may be compared to a threshold (e.g., 90%). Each non-zero node that has a probability at or over the threshold, may be included in a subset of nodes. The subset of nodes may then be processed using the GSM to produce one or more solutions. Because the subset of nodes excludes any zero-nodes, the time needed to run the GSM may be reduced by several orders of magnitude. Therefore, the computing power and time needed to generate solutions for complex supply chain logistics may be reduced. Furthermore, the generated solutions may be transmitted to other computing systems in order to make related computations more efficient.

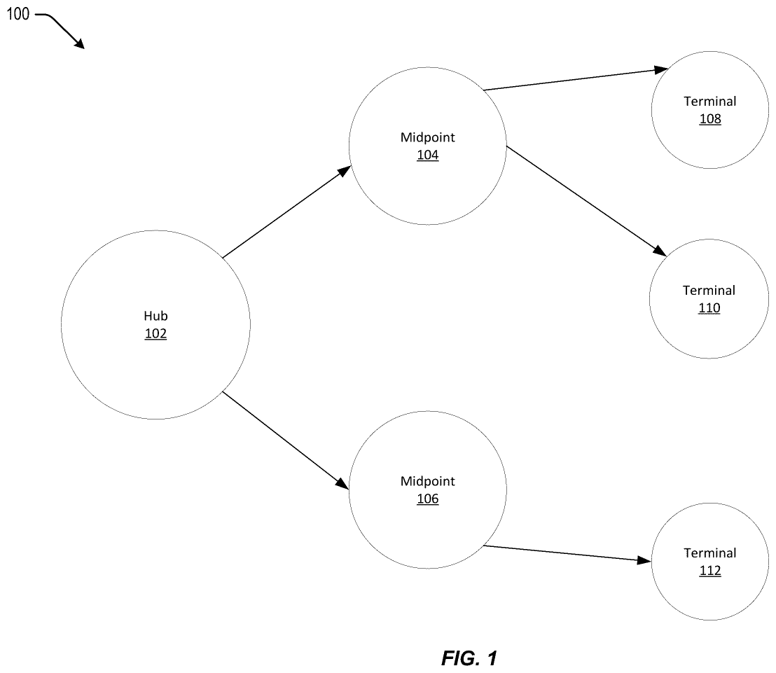

FIG. 1 illustrates a simplified diagram of a logistics chain 100, according to certain embodiments. The multi-node problem 100 may represent a simple logistics chain. The multi-node problem may include a hub 102, midpoints 104 and 106, and terminals 108-112. The hub 102 may be a root of the logistics chain. The hub 102 may supply midpoints 104 and 106 with one or more inventory items. The hub 102 may therefore be a “predecessor” of the midpoints 104 and 106, and the midpoints 104 and 106 may be referred “successors” to the hub 102.

The midpoint 104 may supply the terminal 108 and/or the terminal 110 with the one or more inventory items. The midpoint 104 may therefore be a predecessor to the terminals 108 and 110, and the terminals 108 and 110 may be successors to the midpoint 104. Similarly, the midpoint 106 may supply the terminal 112 with the one or more inventory and be a predecessor to the terminal 112. The terminal 112 may then be a successor to the midpoint 106.

The one or more inventory items may flow through the logistics chain from the hub 102 to the terminals 108-112. The multi-node problem 100 may only represent locations in the logistics chain where the one or more inventory items are held and/or distributed. For example, each of the hub 102, the midpoints 104-106 and the terminals 108-112 may hold a certain amount of each of the one or more inventory items, receiving and/or releasing the one or more inventory items due in part to actions of other locations within the logistics chain. A node within the logistics chain may be defined as a particular amount of an inventory item held at a particular location.

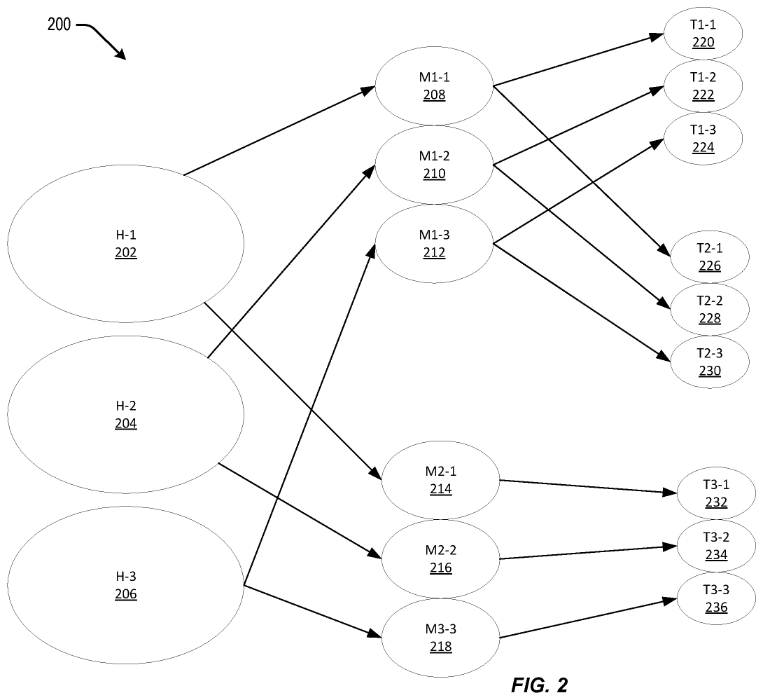

FIG. 2 illustrates a simplified multi-node problem 200, according to certain embodiments. The multi-node problem 200 may represent the locations included in the logistics chain 100 in FIG. 1 with three inventory items. Each location may therefore be associated with three nodes in the multi-node problem 200. For example, a node H-1 may be associated with the hub 102 and an inventory item 1. A node H-2 may be associated with the hub 102 and an inventory item 2. A node H-3 may be associated with the hub 102 and an inventory item 3. Similarly, nodes labelled as “M1” may represent the midpoint 104 and a respective inventory item. For example, the node M1-1 may represent the midpoint 104 and the inventory item 1, a node M1-2 may represent the midpoint 104 and the inventory item 2, etc. Nodes labelled as “M2” may represent the midpoint 106 and the respective inventory item in the same manner. Nodes labelled as “T1” may represent the terminal 108 and a respective inventory item. Nodes labelled as T2 may represent the terminal 110 and a respective inventory item, and nodes labelled as T3 may represent the terminal 112 and a respective inventory item.

Each node in the multi-node problem 200 may be characterized by a particular value, based on an amount of the inventory item each node may hold. For example, the node H1-1 may be characterized with 5, meaning that the hub 102 holds 5 of inventory item 1. The node M1-1 may be characterized by 10, meaning that the midpoint 104 holds 10 of inventory item 1. The node M1-2 may be characterized by 7, meaning the midpoint 104 holds 7 of inventory item 2. The particular values of the multi-node problem may represent theoretical values, estimates of what each node should hold, what each node currently holds, an average inventory level, or other such values.

To improve an efficiency of the logistics chain 100, an optimal inventory level for each node may be determined. The optimal inventory level for each node may be based on one or more node features. For each node, the node features may include a number of successors, a number of predecessors, a distance to the root, a mean demand, a demand variance, a lead time mean, a lead time variance, a holding cost, and a service level ratio. Other factors may also be considered, such as industry specific requirements. Some of the node features may be dependent on other node (e.g., distance to the root, the number of successors/predecessors, etc.).

One method for finding the optimal inventory is to solve the multi-node problem using the GSM algorithm. The particular values associated with each node may then represent an optimized inventory level. In other words, each node maintains an inventory level such that the demands of each other node in the multi-node problem are met. However, even a simple multi-node problem such as the multi-node problem 200 grows in complexity quickly. As the number of nodes and connections between nodes (“arcs”) grows linearly, a solution time needed for the GSM algorithm grows exponentially.

Whereas multi-node problem 200 may have 18 nodes total, modern logistics chains may have thousands or millions of nodes. The time needed to solve a multi-node problem for such a large logistics chain using the GSM may be measured in years or longer, rendering the GSM impractical to use. Dedicating greater computational resources towards solving the multi-node problem may reduce the time somewhat but may also lead to greater cost.

In some solutions to multi-node problems, there may be one or more nodes whose optimal inventory level is zero. If these zero-nodes could be identified, the multi-node problem may be reduced in complexity by eliminating the multi-node problems to include only a subset of nodes with an optimized inventory level greater than zero. The subset of nodes may then be provided to a computing device that applies the GSM to solve the multi-node problem including just the subset of nodes. Generally, the GSM may be required to already be applied to the all of the nodes in the multi-node problem to find zero- and/or non-zero nodes of an optimized solution. A method of determining zero- and/or non-zero nodes for a given multi-node problem prior to applying the GSM may allow the GSM to only consider the subset of nodes. The solution time may therefore be reduced exponentially, saving time and computing power. The solutions generated using the subset of nodes may be provided to other computing devices performing related calculations, saving more time and computing power.

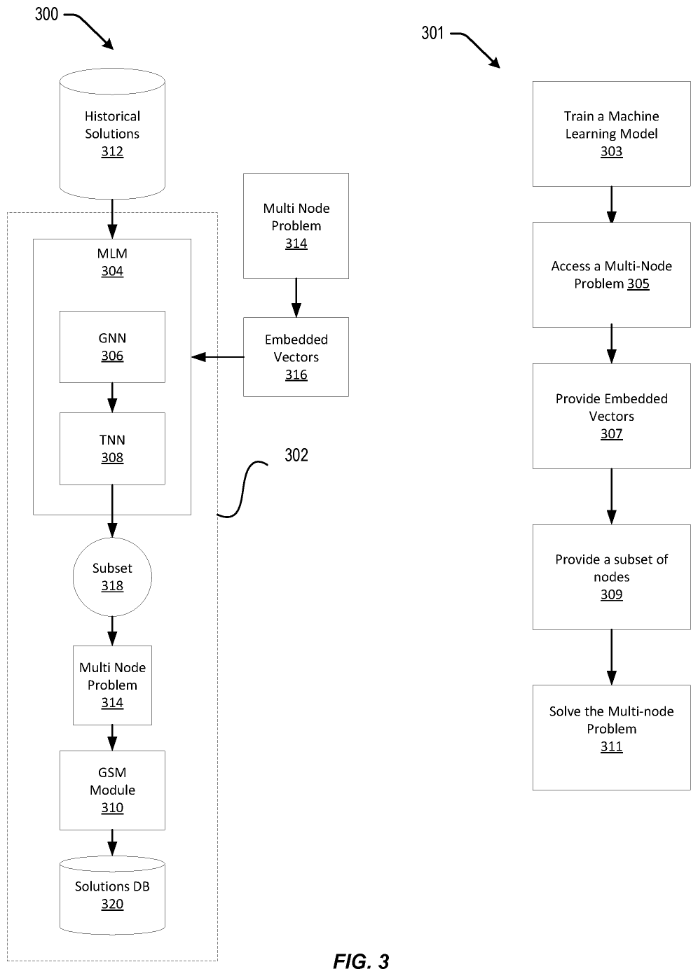

FIG. 3 illustrates a system 300 and a process 301 for identifying zero-nodes, according to certain embodiments. The system 300 may include a computing system 302. The computing system 302 may be a single computing device or multiple computing devices. In some embodiments, the computing system 302 may be a cloud computing system. Thus, some or all of the components shown in the computing system 302 may be distributed across one or more computing devices. The computing system 302 may include a machine learning model (MLM) 304. The MLM 304 may include a graph neural network (GNN) 306 and a transformer neural network (TNN) 308. The computing system 302 may also include a Guaranteed Service Model (GSM) module 310, configured to generate an optimized solution for a multi-node problem (e.g., and MEIO). The computing system 302 may also include a solutions database 320. The solutions database 320 may store solutions to multi-node problems generated by the computing system 302.

At step 303, the process 301 includes training the MLM 304 using historical solutions 332. The historical solutions 332 may include one or more solutions to multi-node problems. The one or more solutions may include optimized solutions to MEIO problems, generated using the GSM algorithm. Training the MLM 304 may include training the MLM 304 to identify nodes as zero- and/or non-zero nodes.

For example, an optimized solution to an MEIO problem may include one or more zero-nodes. The MLM 304 may identify one or more node features associated with the zero-nodes in the historical solutions 312. The one or more node features may include a number of successors, a number of predecessors, a distance to the root, a mean demand, a demand variance, a lead time mean, a lead time variance, a holding cost, and a service level ratio. Other relevant factors may also be considered, such as industry specific requirements.

At step 305, the process 301 includes accessing a multi-node problem 314. The multi-node problem 314 may be a MEIO problem and/or represent a logistics chain. The multi-node problem 314 may have any number of nodes and arcs, and therefore be of any level of complexity. The multi-node problem 314 may require prohibitive amounts of time and/or computing power (and related energy) to solve using the GSM.

At step 307, the process 301 may include providing embedded vectors 316 to the MLM 304. Each of the embedded vectors 316 may represent a particular node of the multi-node problem 314. For example, in reference to the multi-node problem 200 in FIG. 2, the node T1-3 and associated node features may be represented as an embedded vector of the embedded vectors 316. Any embedded vector 316 may have any number of dimensions, based on the number of node features associated with a particular node. Continuing the example of the node T1-3, the number of successor nodes may be zero, as T1-3 represents the terminal 108 in FIG. 1. Once every node of the multi-node problem 314 has been embedded as one of the embedded vectors 316, the embedded vectors 316 may be provided to the MLM 304.

The embedded vectors 316 may first be provided to the GNN 306 within the MLM 304. The GNN 306 may utilize the embedded vectors 316 to determine an effect each node has on every other node represented by the embedded vectors 316. The GNN 306 may also consider an importance of each node to every other node represented by the embedded vectors 316. For example, in relation to FIG. 2, in considering the node T1-1, the GNN 306 may determine that the node M1-1 is not important to the node T1-1 because T1-1 is not connected to the node M1-1. After considering all nodes represented by the embedded vectors 316, the GNN 306 may generate an output representing causal relations (“edges”) between some or all of the nodes in the multi-node problem 314. The output may include a unique representation of each node.

The output may then be provided to the TNN 308 in the MLM 304. The TNN 308 may act as a binary classification model. The TNN 308 may sort the unique representation of each node output by the GNN 306. In some embodiments, the TNN 308 may sort the output based on a hierarchy associated with the logistics chain represented by the multi-node problem 314. For example, in relation to FIG. 1, the TNN 308 may sort the output by ranking the terminals 108-112 first, the midpoints 104-106 second, and the hub 102 third. In some embodiments, the TNN 308 may sort the output in any other relevant manner. Then, the TNN 308 may determine an importance of each node holding an inventory as compared to other nodes. The TNN 308 may determine a likely minimal inventory level for each node, based at least in part on the importance of a particular node holding an inventory. The likely minimal inventory may be either zero or non-zero. In some embodiments, the node may be associated with a particular value. In other embodiments, the node may only be identified as non-zero.

The node may also be associated with a probability. The probability may represent a likelihood that the minimal inventory for a particular node is zero or non-zero (e.g., a 90% chance) in an optimized solution to the multi-node problem. If the probability is above a certain level (e.g., 85%) for a particular node is a non-zero node, the particular node may be included in the subset of nodes 318. In some embodiments, the subset of nodes 318 may only include nodes that are not zero-nodes.

At step 309, the process 301 includes providing the subset of nodes 318 by the MLM 304. The MLM 304 may output information denoting each node in the multi-node problem 314 as either zero or non-zero. The subset of nodes 318 may only include the non-zero nodes. In some embodiments, the subset of nodes 318 may be substantially smaller than the nodes in the multi-node problem 314. The subset of nodes 318 may then be combined with the multi-node problem 314, such that all of the zero-nodes identified by the MLM 304 are removed from the multi-node problem 314. Because the zero-nodes have been removed from the multi-node problem 314, the complexity of the multi-node problem 314 may be reduced. The computing power, energy, and time needed to solve the multi-node problem may therefore be reduced.

At step 311, the process 301 includes solving the multi-node problem 314 using subset of nodes via the GSM module 310. The GSM module 310 may be a hardware or software component of the computing system 302 configured to apply the GSM module 310 to a multi-node problem. Because the subset of nodes 318 may include substantially fewer nodes than the full multi-node problem 314, the GSM module 310 may take significantly less time to solve the multi-node problem. The GSM module 310 may output a solution to the multi-node problem 314, without considering the zero-nodes identified by the MLM 304. The solution may correspond to an optimized solution to the full multi-node problem 314, solved using the GSM, or may be different.

The solution may then be stored in the solutions database 320. The solutions database 320 may be accessed by one or more other computing systems, performing related computations. Efficiencies may therefore be gained not only by the computing system 302 by reducing the time needed to solve the GSM for the multi-node problem 314, but may also enable the other computing systems to realize similar efficiencies.

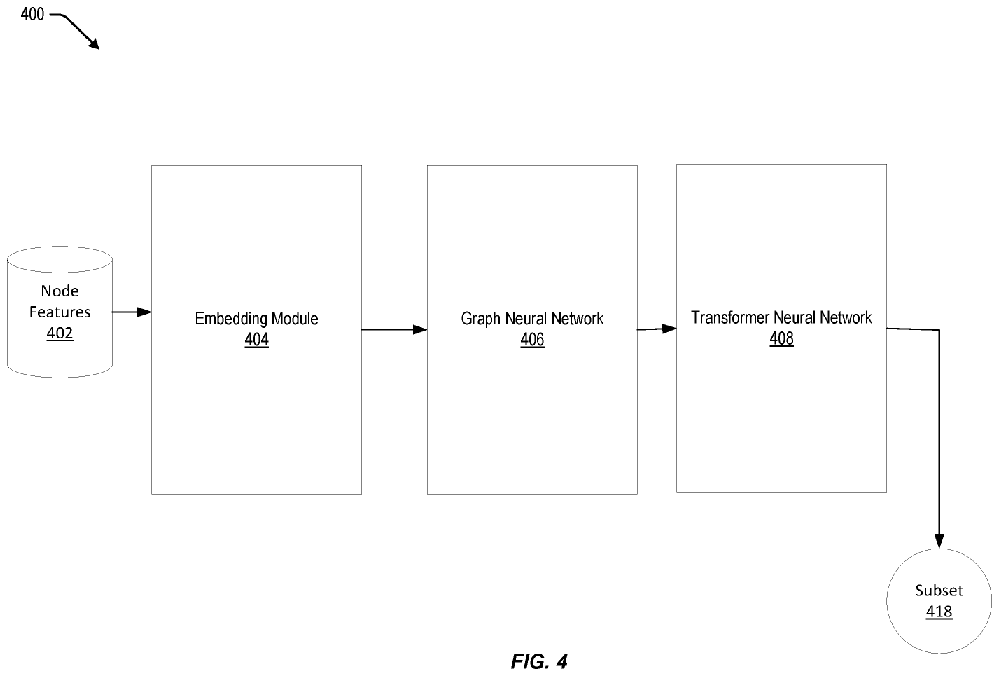

FIG. 4 illustrates a system 400 for identifying a subset of nodes 418, according to certain embodiments. The system 400 may be similar to some or all of the system 300 described in relation to FIG. 3. Some or all of the system 400 may be performed by or with a machine learning model such as the MLM 304. As such, some or all of the components shown in FIG. 4 may be trained using, at least in part, optimized solutions to multi-node problems (e.g., an MEIO problem). The system 400 may include an embedding module 404, a GNN 406, and a TNN 408. The embedding module 404 may be a component of a MLM, or may be a separate computing structure (either physical or logical). In some embodiments, the embedding module 404 may include a user interface, configured to accept values associated with the node features 402. In other embodiments, the embedding module 404 may identify the node features automatically after accessing data associated with a multi-node problem.

The node features 402 may include one or more node features associated with each of a plurality of node features. Each node of the plurality of nodes may have one or more of the node features 402. The node features 402 may include a number of successors, a number of predecessors, a distance to the root, a mean demand, a demand variance, a lead time mean, a lead time variance, a holding cost, and a service level ratio. Other relevant features may also be considered, such as industry specific requirements. In some embodiments, each node feature may be weighted as more or less important.

The embedding module 404 may generate an embedded vector for each node of the plurality of nodes. The embedded vector may represent each of the node features associated with a particular node. The embedded vector may be of a dimension equal to the number of node features associated with the particular node. For example, if the particular node is associated with three node features, the embedded vector may include three dimensions.

The embedding module 404 may provide the embedded vectors associated with the plurality of nodes to the GNN 406. The GNN 406 may be similar to the GNN 306 in FIG. 3. The GNN 406 may first represent each of the embedded vectors as a graph or other representation. In some embodiments, the graph or other representation may be provided by the embedding module. The graph may represent edges between some or all of the nodes in the multi-node problem.

The GNN 406 may utilize an attention mechanism. The attention mechanism may enhance some dimensions of the embedded vectors while diminishing other dimensions. The attention mechanism may include a query and a reference. The query may include a dimension of an embedded vector representing a node feature of a particular node. The reference may be dimensions of some or all of the embedded vectors representing a corresponding node feature associated with a different node. In other words, the attention mechanism of the GNN 406 may compare the node features of a particular node to some or all of the other nodes in the multi-node problem.

Via the attention mechanism, the GNN 406 may determine an effect each node has on every other node represented by the embedded vectors. The GNN 306 may also consider an importance of each node to every other node represented by the embedded vectors. For example, in relation to FIG. 2, in considering the node T1-1, the GNN 406 may determine that the node M2-1 is not important to the node T1-1 because T1-1 is not connected to the node M2-1. After applying the attention mechanism to each of the embedded vectors, the GNN 406 may generate an output representing (“edges”) between some or all of the nodes in the multi-node problem. The output may include a unique representation of each node.

The output is then provided to the TNN 408. The TNN 408 may include a multi-head attention layer and/or a masked multi-head attention layer (together, “layers”). Using the layers, the TNN 408 may determine if a node is required to hold inventory in an optimized solution. To do so, the TNN 408 may sort the unique representations of the plurality of nodes. In some embodiments, the TNN 408 may sort the plurality of nodes by a location in a logistics chain. For example, the plurality of nodes may be sorted by most downstream (e.g., the terminal 108 in FIG. 1) to the most upstream (e.g., 102). Each echelon (e.g., the terminals 108-112 in FIG. 1) may be further sorted by a number of direct neighbors, associated with each node (e.g., the terminals 108 and 110 each have 1 direct neighbor, terminal 112 has no direct neighbors).

Once the plurality of nodes is sorted, the layers may determine an importance of holding inventory associated with each node. The layers may determine the importance in parallel, examining multiple nodes simultaneously and combining the results into a single importance level assigned to each node. The TNN 408 then combines the importance assigned to sorted nodes, such that a sorted list of nodes includes the importance of holding inventory associated with each node.

Next, the TNN 408 may minimize a function to find a minimal inventory level for each node of the plurality of nodes. In some embodiments, the function may be SoftMax loss function. In other embodiments, other logistical functions may be applied. The result may be a minimal inventory level associated with each node and/or a probability associated with each node. The probability may represent a likelihood that an optimized solution to the multi-node problem containing a node would determine the same minimal inventory level for that node. In some embodiments, all nodes of the plurality of nodes may have the same probability. In other embodiments, the probability of each node may be independent of other probabilities.

The TNN 408 may then assign a zero or a non-zero to each node of the plurality of nodes based on the minimal inventory level determined by minimizing the function. In other words, the TNN 408 may provide a binary output for the plurality of nodes, where each node is either zero or non-zero. The probability of each non-zero node may then be compared to a predetermined threshold (e.g., 90%). The predetermined threshold may be configurable in order to provide a particular confidence level in the output. For example, a particular node may be identified as a non-zero node, with a probability of 95%. In other words, there may be a 95% probability that the particular node is non-zero in an optimized solution to the multi-node problem. Because the probability is above the example predetermined threshold (90%), the particular node may be included in a subset of nodes 418. If another node is identified as a zero-node with a 92% liability, the other node may not be included in the subset of nodes 418. Yet another node may be identified as a non-zero node with an 85% probability, and therefore be excluded from the subset of nodes 418. Thus, the subset of nodes 418 may only include non-zero nodes over a certain probability of being non-zero in an optimized solution. In other embodiments, the subset of nodes 418 include all nodes that are not identified as zero-nodes and are above a certain threshold. One of ordinary skill in the art would recognize many different possibilities and configurations.

The subset of nodes 418 may then be used to solve the multi-node problem using the GSM algorithm. Depending on how selective the predetermined parameter is, the computing resources, time, and/or energy needed to solve the multi-node problem may be significantly reduced. For some multi-node problems, a relatively low threshold may be selected (e.g., 70%) resulting in greater efficiencies in computing problems. For others, a higher threshold (e.g., 90%) may be selected in order to generate greater accuracy but still provide significant efficiencies.

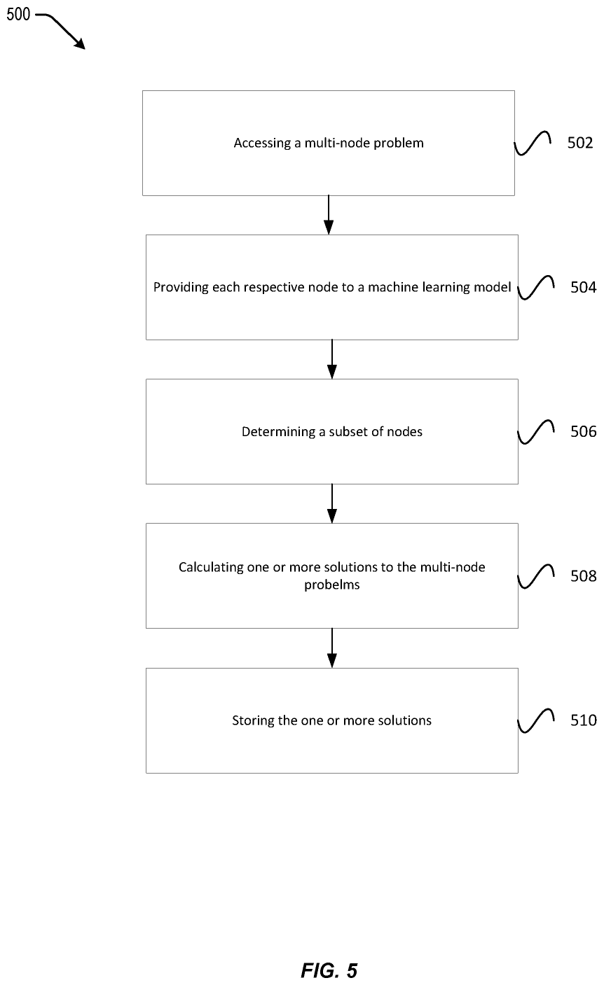

FIG. 5 illustrates a flowchart of a method 500 for generating solutions to a multi-node problem, according to certain embodiments. The method 500 may be performed by one or more computing system, such as the computing system 302 in FIG. 3. The method 500 may be used to solve a multi-node problem in part by determine zero-nodes included in an optimized solution to the multi-node problem prior to solving the multi-node problem. At step 502, the method 500 includes accessing a multi-node problem by a computing system. The multi-node problem may include a plurality of nodes, each having one or more node features. The multi-node problem may represent a logistics chain, such as the logistics chain 100 in FIG. 1 and/or the multi-node problem 200 in FIG. 2. The one or more node features may be similar to the node features 412 in FIG. 4. In some embodiments, the multi-node problem may be a MEIO problem.

At step 504, the method 500 includes providing each respective node and each respective node feature to a machine learning model (MLM). An embedded vector may be generated for each node of the plurality of nodes and the respective associated node features. The embedded vector may therefore represent a node by each of the node features associated with the node. The embedded vector may have dimensions corresponding to the number of node features associated with the node.

The embedded vector may be generated by an embedding module such as the embedding module 404 in FIG. 4 or other such device or computer program. In some embodiments, the embedding module may include a user interface a user interface, configured to accept values associated with the one or more node features. In other embodiments, the embedding module may access the plurality of nodes and automatically determine the one or more node feature associated with each node. In some embodiments, the embedding module may be included in the MLM. In other embodiments, the embedding module may be separate from the MLM.

At step 506, the method 500 includes determining a subset of nodes by the computing system, based at least in part on the respective node features. The computing system may use the MLM to determine the subset of nodes. The MLM may be similar to the MLM 304 in FIG. 3 and/or some or all of the components of the system 400 in FIG. 4. The MLM may therefore include a GNN (e.g., the GNN 406) and/or a TNN (e.g., the TNN 408). The GNN may receive the embedded vectors and generate a unique representation of each node of the plurality of nodes based on the respective node features. To do so, the GNN may determine an importance of holding inventory for each node compared to some or all of the other nodes in the plurality of nodes. The GNN may also determine an effect a node may have on some or all of the other nodes of the plurality of nodes. The GNN may then provide the unique representation of each node to the TNN.

The TNN may then sort the plurality of nodes (or the unique representations thereof). In some embodiments, the plurality of nodes is sorted according to a location each node is associated with in a logistical chain. For example, the plurality of nodes may be sorted by the most downstream (e.g., the terminal 108 in FIG. 1) to the most upstream (e.g., 102). Each echelon (e.g., the terminals 108-112 in FIG. 1) may be further sorted by a number of direct neighbors, associated with each node (e.g., the terminals 108 and 110 each have 1 direct neighbor, terminal 112 has no direct neighbors).

The TNN may determine an importance that each node of the plurality of nodes holds inventory, as compared to other nodes. The TNN may then determine a minimal value associated with each of the plurality of nodes. The minimal value may be determined via minimizing a function (e.g., the Softmax loss function or other suitable functions). The minimal value may be associated with a minimal inventory level associated with each node in an optimal solution.

The TNN may generate a binary output for each node of the plurality of nodes based at least in part on the minimal value. The binary output may include zero or non-zero. In other words, if a particular node would be a zero-node in the optimal solution, the TNN may identify the particular node as a zero-node. On the other hand, if another node would be a non-zero node in the optimal solution, the TNN may identify the other node accordingly.

The TNN may also assign a probability that the minimal value associated with each node is the same inventory level associated with the node in the optimal solution. The probability may then be compared to a predetermined threshold (e.g., 90%). Nodes identified as non-zero and are characterized by a probability of greater than or equal to the predetermined threshold may be included in the subset of nodes. In other words, the zero-nodes may be excluded from the subset of nodes.

At step 508, the method 500 includes calculating one or more solutions to the multi-node problem based at least in part on the subset of nodes. The computing system may provide a dynamic programming algorithm such as the GSM algorithm to calculate the one or more solutions. In some embodiments, the computing system may only utilize the subset of nodes to calculate the one or more solutions. Because the subset of nodes may be smaller than the total amount of nodes in the multi-node problem, the computing system may decrease a solution time needed to find the one or more solutions exponentially. Thus, the computing system may utilize less computing power and/or energy, leading to greater efficiencies.

At step 510, the method 500 includes storing the one or more solutions to the multi-node problem in a computer memory. In some embodiments, the computer memory may be a solutions database such as the solutions database 320 in FIG. 3. The one or more solutions may be accessed by other computing systems performing related calculations. Therefore, the other computing systems may also use less time, computing power, and/or energy in calculating solutions to the multi-node problem.

In some embodiments, the MLM may be trained on a historical dataset such as the historical dataset 312 in FIG. 3. The historical dataset may include one or more solutions to previously solved MEIO problems using the GSM algorithm. In some embodiments, the one or more solutions may be used to retrain the MLM. The one or more solutions used to retrain the MLM may include rewards or other feedback to tune the MLM model to a specific use case (e.g., health care, human resources, etc.).

### BRIEF DESCRIPTION OF DRAWINGS

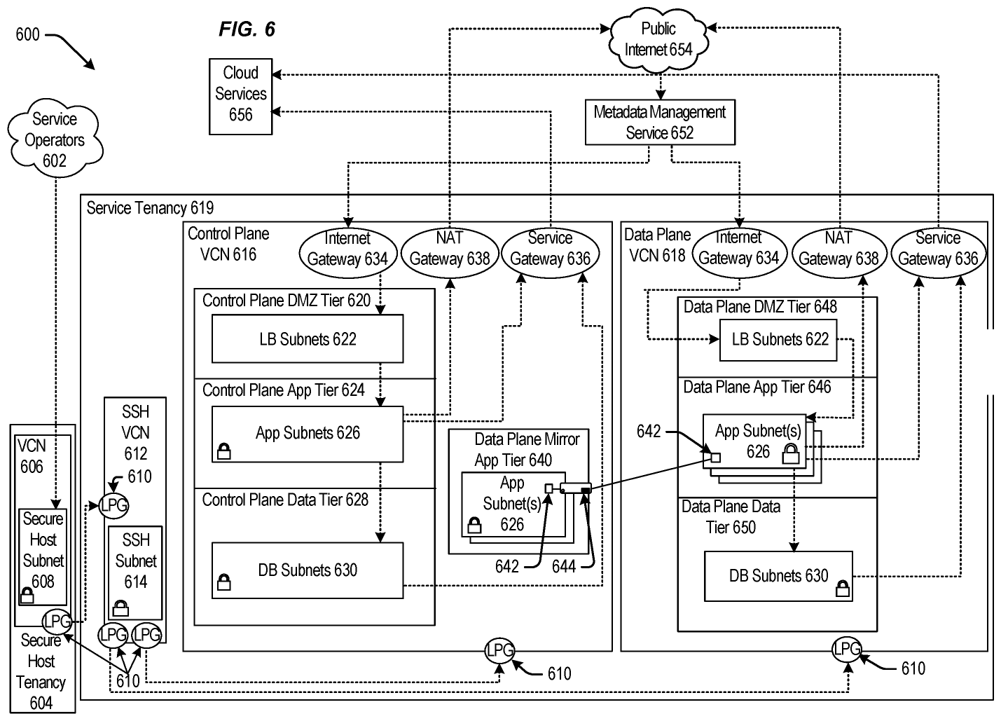

FIG. 6 is a block diagram illustrating one pattern for implementing a cloud infrastructure as a service system, according to at least one embodiment.

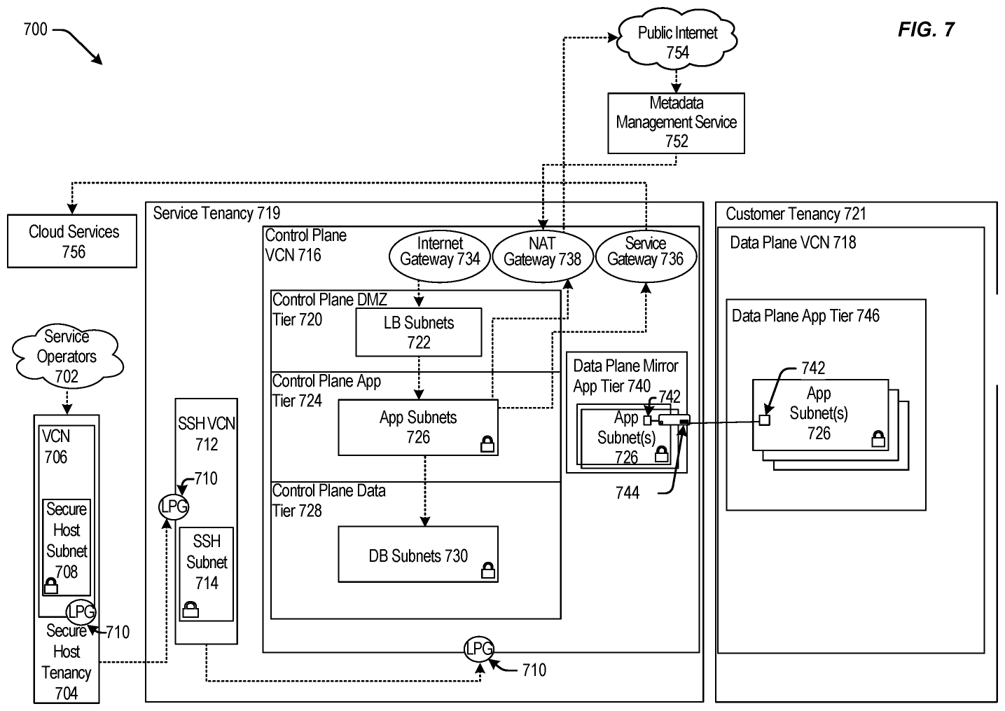

FIG. 7 is a block diagram illustrating another pattern for implementing a cloud infrastructure as a service system, according to at least one embodiment.

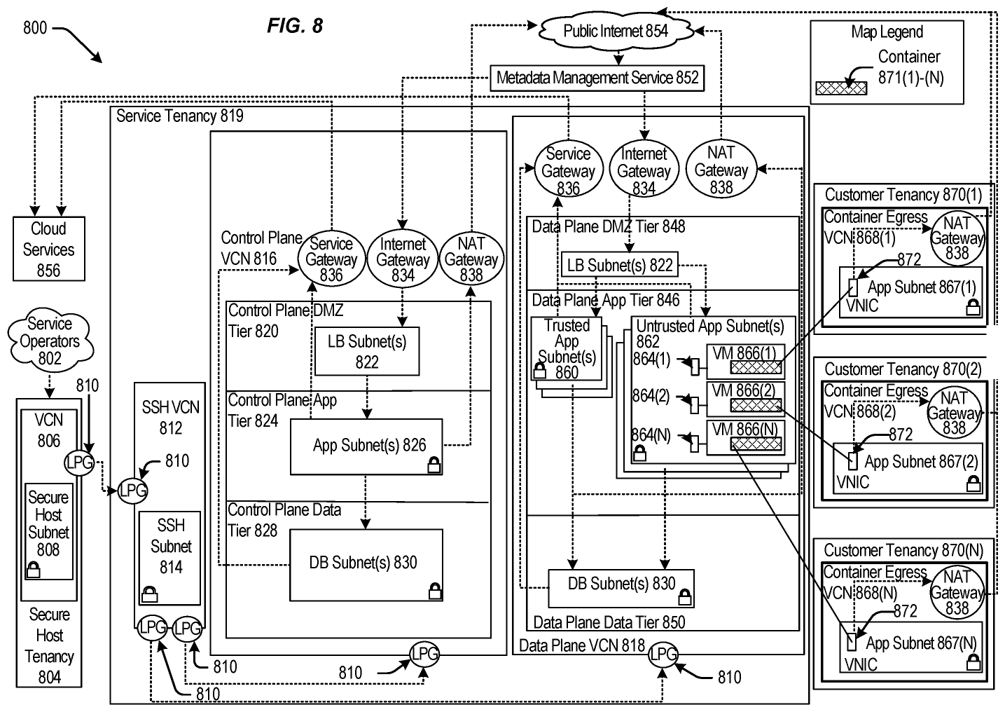

FIG. 8 is a block diagram illustrating another pattern for implementing a cloud infrastructure as a service system, according to at least one embodiment.

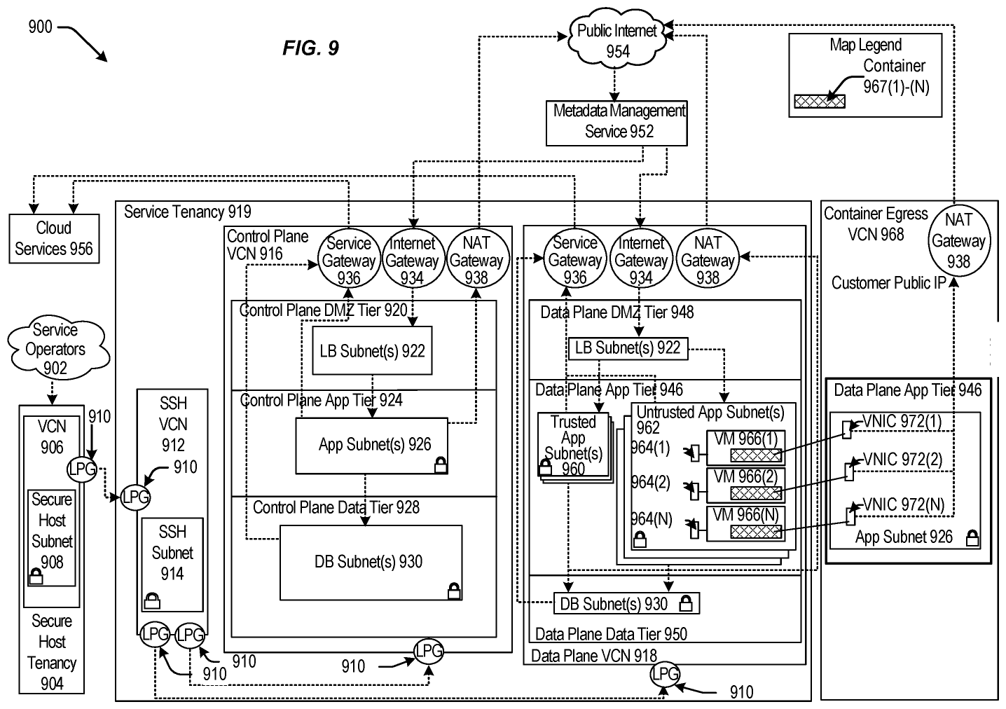

FIG. 9 is a block diagram illustrating another pattern for implementing a cloud infrastructure as a service system, according to at least one embodiment.

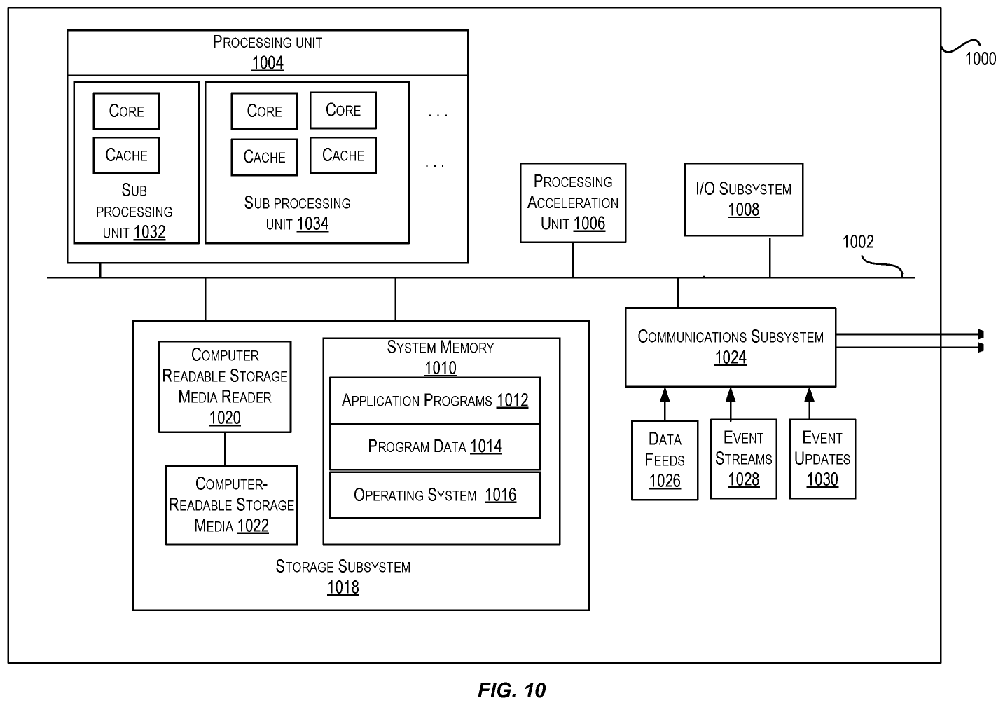

FIG. 10 is a block diagram illustrating an example computer system, according to at least one embodiment.

### Boilerplate Description

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 6 is a block diagram 600 illustrating an example pattern of an IaaS architecture, according to at least one embodiment. Service operators 602 can be communicatively coupled to a secure host tenancy 604 that can include a virtual cloud network (VCN) 606 and a secure host subnet 608. In some examples, the service operators 602 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 606 and/or the Internet.

The VCN 606 can include a local peering gateway (LPG) 610 that can be communicatively coupled to a secure shell (SSH) VCN 612 via an LPG 610 contained in the SSH VCN 612. The SSH VCN 612 can include an SSH subnet 614, and the SSH VCN 612 can be communicatively coupled to a control plane VCN 616 via the LPG 610 contained in the control plane VCN 616. Also, the SSH VCN 612 can be communicatively coupled to a data plane VCN 618 via an LPG 610. The control plane VCN 616 and the data plane VCN 618 can be contained in a service tenancy 619 that can be owned and/or operated by the IaaS provider.

The control plane VCN 616 can include a control plane demilitarized zone (DMZ) tier 620 that acts as a perimeter network (e.g., portions of a corporate network between the corporate intranet and external networks). The DMZ-based servers may have restricted responsibilities and help keep breaches contained. Additionally, the DMZ tier 620 can include one or more load balancer (LB) subnet(s) 622, a control plane app tier 624 that can include app subnet(s) 626, a control plane data tier 628 that can include database (DB) subnet(s) 630 (e.g., frontend DB subnet(s) and/or backend DB subnet(s)). The LB subnet(s) 622 contained in the control plane DMZ tier 620 can be communicatively coupled to the app subnet(s) 626 contained in the control plane app tier 624 and an Internet gateway 634 that can be contained in the control plane VCN 616, and the app subnet(s) 626 can be communicatively coupled to the DB subnet(s) 630 contained in the control plane data tier 628 and a service gateway 636 and a network address translation (NAT) gateway 638. The control plane VCN 616 can include the service gateway 636 and the NAT gateway 638.

The control plane VCN 616 can include a data plane mirror app tier 640 that can include app subnet(s) 626. The app subnet(s) 626 contained in the data plane mirror app tier 640 can include a virtual network interface controller (VNIC) 642 that can execute a compute instance 644. The compute instance 644 can communicatively couple the app subnet(s) 626 of the data plane mirror app tier 640 to app subnet(s) 626 that can be contained in a data plane app tier 646.

The data plane VCN 618 can include the data plane app tier 646, a data plane DMZ tier 648, and a data plane data tier 650. The data plane DMZ tier 648 can include LB subnet(s) 622 that can be communicatively coupled to the app subnet(s) 626 of the data plane app tier 646 and the Internet gateway 634 of the data plane VCN 618. The app subnet(s) 626 can be communicatively coupled to the service gateway 636 of the data plane VCN 618 and the NAT gateway 638 of the data plane VCN 618. The data plane data tier 650 can also include the DB subnet(s) 630 that can be communicatively coupled to the app subnet(s) 626 of the data plane app tier 646.

The Internet gateway 634 of the control plane VCN 616 and of the data plane VCN 618 can be communicatively coupled to a metadata management service 652 that can be communicatively coupled to public Internet 654. Public Internet 654 can be communicatively coupled to the NAT gateway 638 of the control plane VCN 616 and of the data plane VCN 618. The service gateway 636 of the control plane VCN 616 and of the data plane VCN 618 can be communicatively couple to cloud services 656.

In some examples, the service gateway 636 of the control plane VCN 616 or of the data plane VCN 618 can make application programming interface (API) calls to cloud services 656 without going through public Internet 654. The API calls to cloud services 656 from the service gateway 636 can be one-way: the service gateway 636 can make API calls to cloud services 656, and cloud services 656 can send requested data to the service gateway 636. But, cloud services 656 may not initiate API calls to the service gateway 636.

In some examples, the secure host tenancy 604 can be directly connected to the service tenancy 619, which may be otherwise isolated. The secure host subnet 608 can communicate with the SSH subnet 614 through an LPG 610 that may enable two-way communication over an otherwise isolated system. Connecting the secure host subnet 608 to the SSH subnet 614 may give the secure host subnet 608 access to other entities within the service tenancy 619.

The control plane VCN 616 may allow users of the service tenancy 619 to set up or otherwise provision desired resources. Desired resources provisioned in the control plane VCN 616 may be deployed or otherwise used in the data plane VCN 618. In some examples, the control plane VCN 616 can be isolated from the data plane VCN 618, and the data plane mirror app tier 640 of the control plane VCN 616 can communicate with the data plane app tier 646 of the data plane VCN 618 via VNICs 642 that can be contained in the data plane mirror app tier 640 and the data plane app tier 646.

In some examples, users of the system, or customers, can make requests, for example create, read, update, or delete (CRUD) operations, through public Internet 654 that can communicate the requests to the metadata management service 652. The metadata management service 652 can communicate the request to the control plane VCN 616 through the Internet gateway 634. The request can be received by the LB subnet(s) 622 contained in the control plane DMZ tier 620. The LB subnet(s) 622 may determine that the request is valid, and in response to this determination, the LB subnet(s) 622 can transmit the request to app subnet(s) 626 contained in the control plane app tier 624. If the request is validated and requires a call to public Internet 654, the call to public Internet 654 may be transmitted to the NAT gateway 638 that can make the call to public Internet 654. Metadata that may be desired to be stored by the request can be stored in the DB subnet(s) 630.

In some examples, the data plane mirror app tier 640 can facilitate direct communication between the control plane VCN 616 and the data plane VCN 618. For example, changes, updates, or other suitable modifications to configuration may be desired to be applied to the resources contained in the data plane VCN 618. Via a VNIC 642, the control plane VCN 616 can directly communicate with, and can thereby execute the changes, updates, or other suitable modifications to configuration to, resources contained in the data plane VCN 618.

In some embodiments, the control plane VCN 616 and the data plane VCN 618 can be contained in the service tenancy 619. In this case, the user, or the customer, of the system may not own or operate either the control plane VCN 616 or the data plane VCN 618. Instead, the IaaS provider may own or operate the control plane VCN 616 and the data plane VCN 618, both of which may be contained in the service tenancy 619. This embodiment can enable isolation of networks that may prevent users or customers from interacting with other users', or other customers', resources. Also, this embodiment may allow users or customers of the system to store databases privately without needing to rely on public Internet 654, which may not have a desired level of threat prevention, for storage.

In other embodiments, the LB subnet(s) 622 contained in the control plane VCN 616 can be configured to receive a signal from the service gateway 636. In this embodiment, the control plane VCN 616 and the data plane VCN 618 may be configured to be called by a customer of the IaaS provider without calling public Internet 654. Customers of the IaaS provider may desire this embodiment since database(s) that the customers use may be controlled by the IaaS provider and may be stored on the service tenancy 619, which may be isolated from public Internet 654.

FIG. 7 is a block diagram 700 illustrating another example pattern of an IaaS architecture, according to at least one embodiment. Service operators 702 (e.g., service operators 602 of FIG. 6) can be communicatively coupled to a secure host tenancy 704 (e.g., the secure host tenancy 604 of FIG. 6) that can include a virtual cloud network (VCN) 706 (e.g., the VCN 606 of FIG. 6) and a secure host subnet 708 (e.g., the secure host subnet 608 of FIG. 6). The VCN 706 can include a local peering gateway (LPG) 710 (e.g., the LPG 610 of FIG. 6) that can be communicatively coupled to a secure shell (SSH) VCN 712 (e.g., the SSH VCN 612 of FIG. 6) via an LPG 610 contained in the SSH VCN 712. The SSH VCN 712 can include an SSH subnet 714 (e.g., the SSH subnet 614 of FIG. 6), and the SSH VCN 712 can be communicatively coupled to a control plane VCN 716 (e.g., the control plane VCN 616 of FIG. 6) via an LPG 710 contained in the control plane VCN 716. The control plane VCN 716 can be contained in a service tenancy 719 (e.g., the service tenancy 619 of FIG. 6), and the data plane VCN 718 (e.g., the data plane VCN 618 of FIG. 6) can be contained in a customer tenancy 721 that may be owned or operated by users, or customers, of the system.

The control plane VCN 716 can include a control plane DMZ tier 720 (e.g., the control plane DMZ tier 620 of FIG. 6) that can include LB subnet(s) 722 (e.g., LB subnet(s) 622 of FIG. 6), a control plane app tier 724 (e.g., the control plane app tier 624 of FIG. 6) that can include app subnet(s) 726 (e.g., app subnet(s) 626 of FIG. 6), a control plane data tier 728 (e.g., the control plane data tier 628 of FIG. 6) that can include database (DB) subnet(s) 730 (e.g., similar to DB subnet(s) 630 of FIG. 6). The LB subnet(s) 722 contained in the control plane DMZ tier 720 can be communicatively coupled to the app subnet(s) 726 contained in the control plane app tier 724 and an Internet gateway 734 (e.g., the Internet gateway 634 of FIG. 6) that can be contained in the control plane VCN 716, and the app subnet(s) 726 can be communicatively coupled to the DB subnet(s) 730 contained in the control plane data tier 728 and a service gateway 736 (e.g., the service gateway 636 of FIG. 6) and a network address translation (NAT) gateway 738 (e.g., the NAT gateway 638 of FIG. 6). The control plane VCN 716 can include the service gateway 736 and the NAT gateway 738.

The control plane VCN 716 can include a data plane mirror app tier 740 (e.g., the data plane mirror app tier 640 of FIG. 6) that can include app subnet(s) 726. The app subnet(s) 726 contained in the data plane mirror app tier 740 can include a virtual network interface controller (VNIC) 742 (e.g., the VNIC of 642) that can execute a compute instance 744 (e.g., similar to the compute instance 644 of FIG. 6). The compute instance 744 can facilitate communication between the app subnet(s) 726 of the data plane mirror app tier 740 and the app subnet(s) 726 that can be contained in a data plane app tier 746 (e.g., the data plane app tier 646 of FIG. 6) via the VNIC 742 contained in the data plane mirror app tier 740 and the VNIC 742 contained in the data plane app tier 746.

The Internet gateway 734 contained in the control plane VCN 716 can be communicatively coupled to a metadata management service 752 (e.g., the metadata management service 652 of FIG. 6) that can be communicatively coupled to public Internet 754 (e.g., public Internet 654 of FIG. 6). Public Internet 754 can be communicatively coupled to the NAT gateway 738 contained in the control plane VCN 716. The service gateway 736 contained in the control plane VCN 716 can be communicatively couple to cloud services 756 (e.g., cloud services 656 of FIG. 6).

In some examples, the data plane VCN 718 can be contained in the customer tenancy 721. In this case, the IaaS provider may provide the control plane VCN 716 for each customer, and the IaaS provider may, for each customer, set up a unique compute instance 744 that is contained in the service tenancy 719. Each compute instance 744 may allow communication between the control plane VCN 716, contained in the service tenancy 719, and the data plane VCN 718 that is contained in the customer tenancy 721. The compute instance 744 may allow resources, that are provisioned in the control plane VCN 716 that is contained in the service tenancy 719, to be deployed or otherwise used in the data plane VCN 718 that is contained in the customer tenancy 721.

In other examples, the customer of the IaaS provider may have databases that live in the customer tenancy 721. In this example, the control plane VCN 716 can include the data plane mirror app tier 740 that can include app subnet(s) 726. The data plane mirror app tier 740 can reside in the data plane VCN 718, but the data plane mirror app tier 740 may not live in the data plane VCN 718. That is, the data plane mirror app tier 740 may have access to the customer tenancy 721, but the data plane mirror app tier 740 may not exist in the data plane VCN 718 or be owned or operated by the customer of the IaaS provider. The data plane mirror app tier 740 may be configured to make calls to the data plane VCN 718 but may not be configured to make calls to any entity contained in the control plane VCN 716. The customer may desire to deploy or otherwise use resources in the data plane VCN 718 that are provisioned in the control plane VCN 716, and the data plane mirror app tier 740 can facilitate the desired deployment, or other usage of resources, of the customer.

In some embodiments, the customer of the IaaS provider can apply filters to the data plane VCN 718. In this embodiment, the customer can determine what the data plane VCN 718 can access, and the customer may restrict access to public Internet 754 from the data plane VCN 718. The IaaS provider may not be able to apply filters or otherwise control access of the data plane VCN 718 to any outside networks or databases. Applying filters and controls by the customer onto the data plane VCN 718, contained in the customer tenancy 721, can help isolate the data plane VCN 718 from other customers and from public Internet 754.

In some embodiments, cloud services 756 can be called by the service gateway 736 to access services that may not exist on public Internet 754, on the control plane VCN 716, or on the data plane VCN 718. The connection between cloud services 756 and the control plane VCN 716 or the data plane VCN 718 may not be live or continuous. Cloud services 756 may exist on a different network owned or operated by the IaaS provider. Cloud services 756 may be configured to receive calls from the service gateway 736 and may be configured to not receive calls from public Internet 754. Some cloud services 756 may be isolated from other cloud services 756, and the control plane VCN 716 may be isolated from cloud services 756 that may not be in the same region as the control plane VCN 716. For example, the control plane VCN 716 may be located in “Region 1,” and cloud service “Deployment 6,” may be located in Region 1 and in “Region 2.” If a call to Deployment 6 is made by the service gateway 736 contained in the control plane VCN 716 located in Region 1, the call may be transmitted to Deployment 6 in Region 1. In this example, the control plane VCN 716, or Deployment 6 in Region 1, may not be communicatively coupled to, or otherwise in communication with, Deployment 6 in Region 2.

FIG. 8 is a block diagram 800 illustrating another example pattern of an IaaS architecture, according to at least one embodiment. Service operators 802 (e.g., service operators 602 of FIG. 6) can be communicatively coupled to a secure host tenancy 804 (e.g., the secure host tenancy 604 of FIG. 6) that can include a virtual cloud network (VCN) 806 (e.g., the VCN 606 of FIG. 6) and a secure host subnet 808 (e.g., the secure host subnet 608 of FIG. 6). The VCN 806 can include an LPG 810 (e.g., the LPG 610 of FIG. 6) that can be communicatively coupled to an SSH VCN 812 (e.g., the SSH VCN 612 of FIG. 6) via an LPG 810 contained in the SSH VCN 812. The SSH VCN 812 can include an SSH subnet 814 (e.g., the SSH subnet 614 of FIG. 6), and the SSH VCN 812 can be communicatively coupled to a control plane VCN 816 (e.g., the control plane VCN 616 of FIG. 6) via an LPG 810 contained in the control plane VCN 816 and to a data plane VCN 818 (e.g., the data plane 618 of FIG. 6) via an LPG 810 contained in the data plane VCN 818. The control plane VCN 816 and the data plane VCN 818 can be contained in a service tenancy 819 (e.g., the service tenancy 619 of FIG. 6).

The control plane VCN 816 can include a control plane DMZ tier 820 (e.g., the control plane DMZ tier 620 of FIG. 6) that can include load balancer (LB) subnet(s) 822 (e.g., LB subnet(s) 622 of FIG. 6), a control plane app tier 824 (e.g., the control plane app tier 624 of FIG. 6) that can include app subnet(s) 826 (e.g., similar to app subnet(s) 626 of FIG. 6), a control plane data tier 828 (e.g., the control plane data tier 628 of FIG. 6) that can include DB subnet(s) 830. The LB subnet(s) 822 contained in the control plane DMZ tier 820 can be communicatively coupled to the app subnet(s) 826 contained in the control plane app tier 824 and to an Internet gateway 834 (e.g., the Internet gateway 634 of FIG. 6) that can be contained in the control plane VCN 816, and the app subnet(s) 826 can be communicatively coupled to the DB subnet(s) 830 contained in the control plane data tier 828 and to a service gateway 836 (e.g., the service gateway of FIG. 6) and a network address translation (NAT) gateway 838 (e.g., the NAT gateway 638 of FIG. 6). The control plane VCN 816 can include the service gateway 836 and the NAT gateway 838.

The data plane VCN 818 can include a data plane app tier 846 (e.g., the data plane app tier 646 of FIG. 6), a data plane DMZ tier 848 (e.g., the data plane DMZ tier 648 of FIG. 6), and a data plane data tier 850 (e.g., the data plane data tier 650 of FIG. 6). The data plane DMZ tier 848 can include LB subnet(s) 822 that can be communicatively coupled to trusted app subnet(s) 860 and untrusted app subnet(s) 862 of the data plane app tier 846 and the Internet gateway 834 contained in the data plane VCN 818. The trusted app subnet(s) 860 can be communicatively coupled to the service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the service gateway 836 contained in the data plane VCN 818 and DB subnet(s) 830 contained in the data plane data tier 850. The data plane data tier 850 can include DB subnet(s) 830 that can be communicatively coupled to the service gateway 836 contained in the data plane VCN 818.

The untrusted app subnet(s) 862 can include one or more primary VNICs 864(1)-(N) that can be communicatively coupled to tenant virtual machines (VMs) 866(1)-(N). Each tenant VM 866(1)-(N) can be communicatively coupled to a respective app subnet 867(1)-(N) that can be contained in respective container egress VCNs 868(1)-(N) that can be contained in respective customer tenancies 870(1)-(N). Respective secondary VNICs 872(1)-(N) can facilitate communication between the untrusted app subnet(s) 862 contained in the data plane VCN 818 and the app subnet contained in the container egress VCNs 868(1)-(N). Each container egress VCNs 868(1)-(N) can include a NAT gateway 838 that can be communicatively coupled to public Internet 854 (e.g., public Internet 654 of FIG. 6).

The Internet gateway 834 contained in the control plane VCN 816 and contained in the data plane VCN 818 can be communicatively coupled to a metadata management service 852 (e.g., the metadata management system 652 of FIG. 6) that can be communicatively coupled to public Internet 854. Public Internet 854 can be communicatively coupled to the NAT gateway 838 contained in the control plane VCN 816 and contained in the data plane VCN 818. The service gateway 836 contained in the control plane VCN 816 and contained in the data plane VCN 818 can be communicatively couple to cloud services 856.

In some embodiments, the data plane VCN 818 can be integrated with customer tenancies 870. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 846. Code to run the function may be executed in the VMs 866(1)-(N), and the code may not be configured to run anywhere else on the data plane VCN 818. Each VM 866(1)-(N) may be connected to one customer tenancy 870. Respective containers 871(1)-(N) contained in the VMs 866(1)-(N) may be configured to run the code. In this case, there can be a dual isolation (e.g., the containers 871(1)-(N) running code, where the containers 871(1)-(N) may be contained in at least the VM 866(1)-(N) that are contained in the untrusted app subnet(s) 862), which may help prevent incorrect or otherwise undesirable code from damaging the network of the IaaS provider or from damaging a network of a different customer. The containers 871(1)-(N) may be communicatively coupled to the customer tenancy 870 and may be configured to transmit or receive data from the customer tenancy 870. The containers 871(1)-(N) may not be configured to transmit or receive data from any other entity in the data plane VCN 818. Upon completion of running the code, the IaaS provider may kill or otherwise dispose of the containers 871(1)-(N).

In some embodiments, the trusted app subnet(s) 860 may run code that may be owned or operated by the IaaS provider. In this embodiment, the trusted app subnet(s) 860 may be communicatively coupled to the DB subnet(s) 830 and be configured to execute CRUD operations in the DB subnet(s) 830. The untrusted app subnet(s) 862 may be communicatively coupled to the DB subnet(s) 830, but in this embodiment, the untrusted app subnet(s) may be configured to execute read operations in the DB subnet(s) 830. The containers 871(1)-(N) that can be contained in the VM 866(1)-(N) of each customer and that may run code from the customer may not be communicatively coupled with the DB subnet(s) 830.

In other embodiments, the control plane VCN 816 and the data plane VCN 818 may not be directly communicatively coupled. In this embodiment, there may be no direct communication between the control plane VCN 816 and the data plane VCN 818. However, communication can occur indirectly through at least one method. An LPG 810 may be established by the IaaS provider that can facilitate communication between the control plane VCN 816 and the data plane VCN 818. In another example, the control plane VCN 816 or the data plane VCN 818 can make a call to cloud services 856 via the service gateway 836. For example, a call to cloud services 856 from the control plane VCN 816 can include a request for a service that can communicate with the data plane VCN 818.

FIG. 9 is a block diagram 900 illustrating another example pattern of an IaaS architecture, according to at least one embodiment. Service operators 902 (e.g., service operators 602 of FIG. 6) can be communicatively coupled to a secure host tenancy 904 (e.g., the secure host tenancy 604 of FIG. 6) that can include a virtual cloud network (VCN) 906 (e.g., the VCN 606 of FIG. 6) and a secure host subnet 908 (e.g., the secure host subnet 608 of FIG. 6). The VCN 906 can include an LPG 910 (e.g., the LPG 610 of FIG. 6) that can be communicatively coupled to an SSH VCN 912 (e.g., the SSH VCN 612 of FIG. 6) via an LPG 910 contained in the SSH VCN 912. The SSH VCN 912 can include an SSH subnet 914 (e.g., the SSH subnet 614 of FIG. 6), and the SSH VCN 912 can be communicatively coupled to a control plane VCN 916 (e.g., the control plane VCN 616 of FIG. 6) via an LPG 910 contained in the control plane VCN 916 and to a data plane VCN 918 (e.g., the data plane 618 of FIG. 6) via an LPG 910 contained in the data plane VCN 918. The control plane VCN 916 and the data plane VCN 918 can be contained in a service tenancy 919 (e.g., the service tenancy 619 of FIG. 6).

The control plane VCN 916 can include a control plane DMZ tier 920 (e.g., the control plane DMZ tier 620 of FIG. 6) that can include LB subnet(s) 922 (e.g., LB subnet(s) 622 of FIG. 6), a control plane app tier 924 (e.g., the control plane app tier 624 of FIG. 6) that can include app subnet(s) 926 (e.g., app subnet(s) 626 of FIG. 6), a control plane data tier 928 (e.g., the control plane data tier 628 of FIG. 6) that can include DB subnet(s) 930 (e.g., DB subnet(s) 830 of FIG. 8). The LB subnet(s) 922 contained in the control plane DMZ tier 920 can be communicatively coupled to the app subnet(s) 926 contained in the control plane app tier 924 and to an Internet gateway 934 (e.g., the Internet gateway 634 of FIG. 6) that can be contained in the control plane VCN 916, and the app subnet(s) 926 can be communicatively coupled to the DB subnet(s) 930 contained in the control plane data tier 928 and to a service gateway 936 (e.g., the service gateway of FIG. 6) and a network address translation (NAT) gateway 938 (e.g., the NAT gateway 638 of FIG. 6). The control plane VCN 916 can include the service gateway 936 and the NAT gateway 938.

The data plane VCN 918 can include a data plane app tier 946 (e.g., the data plane app tier 646 of FIG. 6), a data plane DMZ tier 948 (e.g., the data plane DMZ tier 648 of FIG. 6), and a data plane data tier 950 (e.g., the data plane data tier 650 of FIG. 6). The data plane DMZ tier 948 can include LB subnet(s) 922 that can be communicatively coupled to trusted app subnet(s) 960 (e.g., trusted app subnet(s) 860 of FIG. 8) and untrusted app subnet(s) 962 (e.g., untrusted app subnet(s) 862 of FIG. 8) of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include primary VNICs 964(1)-(N) that can be communicatively coupled to tenant virtual machines (VMs) 966(1)-(N) residing within the untrusted app subnet(s) 962. Each tenant VM 966(1)-(N) can run code in a respective container 967(1)-(N), and be communicatively coupled to an app subnet 926 that can be contained in a data plane app tier 946 that can be contained in a container egress VCN 968. Respective secondary VNICs 972(1)-(N) can facilitate communication between the untrusted app subnet(s) 962 contained in the data plane VCN 918 and the app subnet contained in the container egress VCN 968. The container egress VCN can include a NAT gateway 938 that can be communicatively coupled to public Internet 954 (e.g., public Internet 654 of FIG. 6).

The Internet gateway 934 contained in the control plane VCN 916 and contained in the data plane VCN 918 can be communicatively coupled to a metadata management service 952 (e.g., the metadata management system 652 of FIG. 6) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively couple to cloud services 956.

In some examples, the pattern illustrated by the architecture of block diagram 900 of FIG. 9 may be considered an exception to the pattern illustrated by the architecture of block diagram 800 of FIG. 8 and may be desirable for a customer of the IaaS provider if the IaaS provider cannot directly communicate with the customer (e.g., a disconnected region). The respective containers 967(1)-(N) that are contained in the VMs 966(1)-(N) for each customer can be accessed in real-time by the customer. The containers 967(1)-(N) may be configured to make calls to respective secondary VNICs 972(1)-(N) contained in app subnet(s) 926 of the data plane app tier 946 that can be contained in the container egress VCN 968. The secondary VNICs 972(1)-(N) can transmit the calls to the NAT gateway 938 that may transmit the calls to public Internet 954. In this example, the containers 967(1)-(N) that can be accessed in real-time by the customer can be isolated from the control plane VCN 916 and can be isolated from other entities contained in the data plane VCN 918. The containers 967(1)-(N) may also be isolated from resources from other customers.

In other examples, the customer can use the containers 967(1)-(N) to call cloud services 956. In this example, the customer may run code in the containers 967(1)-(N) that requests a service from cloud services 956. The containers 967(1)-(N) can transmit this request to the secondary VNICs 972(1)-(N) that can transmit the request to the NAT gateway that can transmit the request to public Internet 954. Public Internet 954 can transmit the request to LB subnet(s) 922 contained in the control plane VCN 916 via the Internet gateway 934. In response to determining the request is valid, the LB subnet(s) can transmit the request to app subnet(s) 926 that can transmit the request to cloud services 956 via the service gateway 936.

It should be appreciated that IaaS architectures 600, 700, 800, 900 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

FIG. 10 illustrates an example computer system 1000, in which various embodiments may be implemented. The system 1000 may be used to implement any of the computer systems described above. As shown in the figure, computer system 1000 includes a processing unit 1004 that communicates with a number of peripheral subsystems via a bus subsystem 1002. These peripheral subsystems may include a processing acceleration unit 1006, an I/O subsystem 1008, a storage subsystem 1018 and a communications subsystem 1024. Storage subsystem 1018 includes tangible computer-readable storage media 1022 and a system memory 1010.

Bus subsystem 1002 provides a mechanism for letting the various components and subsystems of computer system 1000 communicate with each other as intended. Although bus subsystem 1002 is shown schematically as a single bus, alternative embodiments of the bus subsystem may utilize multiple buses. Bus subsystem 1002 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1004, which can be implemented as one or more integrated circuits (e.g., a conventional microprocessor or microcontroller), controls the operation of computer system 1000. One or more processors may be included in processing unit 1004. These processors may include single core or multicore processors. In certain embodiments, processing unit 1004 may be implemented as one or more independent processing units 1032 and/or 1034 with single or multicore processors included in each processing unit. In other embodiments, processing unit 1004 may also be implemented as a quad-core processing unit formed by integrating two dual-core processors into a single chip.

In various embodiments, processing unit 1004 can execute a variety of programs in response to program code and can maintain multiple concurrently executing programs or processes. At any given time, some or all of the program code to be executed can be resident in processor(s) 1004 and/or in storage subsystem 1018. Through suitable programming, processor(s) 1004 can provide various functionalities described above. Computer system 1000 may additionally include a processing acceleration unit 1006, which can include a digital signal processor (DSP), a special-purpose processor, and/or the like.

I/O subsystem 1008 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1000 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1000 may comprise a storage subsystem 1018 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1004 provide the functionality described above. Storage subsystem 1018 may also provide a repository for storing data used in accordance with the present disclosure.

As depicted in the example in FIG. 10, storage subsystem 1018 can include various components including a system memory 1010, computer-readable storage media 1022, and a computer readable storage media reader 1020. System memory 1010 may store program instructions that are loadable and executable by processing unit 1004. System memory 1010 may also store data that is used during the execution of the instructions and/or data that is generated during the execution of the program instructions. Various different kinds of programs may be loaded into system memory 1010 including but not limited to client applications, Web browsers, mid-tier applications, relational database management systems (RDBMS), virtual machines, containers, etc.

System memory 1010 may also store an operating system 1016. Examples of operating system 1016 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1000 executes one or more virtual machines, the virtual machines along with their guest operating systems (GOSs) may be loaded into system memory 1010 and executed by one or more processors or cores of processing unit 1004.

System memory 1010 can come in different configurations depending upon the type of computer system 1000. For example, system memory 1010 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1010 may include a basic input/output system (BIOS) containing basic routines that help to transfer information between elements within computer system 1000, such as during start-up.

Computer-readable storage media 1022 may represent remote, local, fixed, and/or removable storage devices plus storage media for temporarily and/or more permanently containing, storing, computer-readable information for use by computer system 1000 including instructions executable by processing unit 1004 of computer system 1000.

Computer-readable storage media 1022 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1022 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1022 may include, but is not limited to, Zip® drives, flash memory cards, universal serial bus (USB) flash drives, secure digital (SD) cards, DVD disks, digital video tape, and the like. Computer-readable storage media 1022 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1000.

Machine-readable instructions executable by one or more processors or cores of processing unit 1004 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1024 provides an interface to other computer systems and networks. Communications subsystem 1024 serves as an interface for receiving data from and transmitting data to other systems from computer system 1000. For example, communications subsystem 1024 may enable computer system 1000 to connect to one or more devices via the Internet. In some embodiments communications subsystem 1024 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1024 can provide wired network connectivity (e.g., Ethernet) in addition to or instead of a wireless interface.

In some embodiments, communications subsystem 1024 may also receive input communication in the form of structured and/or unstructured data feeds 1026, event streams 1028, event updates 1030, and the like on behalf of one or more users who may use computer system 1000.

By way of example, communications subsystem 1024 may be configured to receive data feeds 1026 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1024 may also be configured to receive data in the form of continuous data streams, which may include event streams 1028 of real-time events and/or event updates 1030, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1024 may also be configured to output the structured and/or unstructured data feeds 1026, event streams 1028, event updates 1030, and the like to one or more databases that may be in communication with one or more streaming data source computers coupled to computer system 1000.

Computer system 1000 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1000 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

1. A method comprising:
accessing, by a computing system, a multi-node problem comprising a plurality of nodes, each respective node having one or more node features;
providing, by the computing system, each respective node with each respective node feature to a machine learning model;
determining, by the computing system using the machine learning model, a subset of nodes of the plurality of nodes based at least in part on the respective node features; and
calculating, by the computing system, one or more solutions to the multi-node problem based at least in part on the subset of nodes;
storing, by the computing system, the one or more solutions to the multi-node problem in a computer memory.

2. The method of claim 1, wherein the subset of nodes of the plurality of nodes comprises non-zero nodes.

3. The method of claim 1, wherein providing each respective node and each respective node feature further comprises generating an embedded vector comprising one or more dimensions corresponding to each respective node feature.

4. The method of claim 1, wherein determining the subset of nodes further comprises:
determining, by the computing system using the machine learning model, a minimum value associated with each of the plurality of nodes;
determining, by the computing system using the machine learning model, a probability that the minimum value associated with each of the plurality of nodes is a value associated with each node in an optimal solution; and
identifying, by the computing system, the subset of nodes, each node of the subset of nodes identified as non-zero and characterized by a probability greater than or equal to a predetermined threshold.

5. The method of claim 1, wherein the machine learning model comprises a graph neural network.

6. The method of claim 1, wherein the multi-node problem represents a multi-echelon inventory optimization problem.

7. The method of claim 1, wherein calculating the one or more solutions to the multi-node problem utilizes a guaranteed service model.

8. The method of claim 1, wherein the machine learning model is trained at least in part on a historical dataset comprising a plurality of solutions to multi-node problems.

9. The method of claim 1, wherein the one or more solutions to the multi-node problem are provided to a second computing system.

10. A computing system comprising:
one or more processors; and
a non-transitory computer readable medium comprising instructions that, when executed by the one or more processors, cause the system to perform operations to:
access, by the computing system, a multi-node problem comprising a plurality of nodes, each respective node having one or more node features;
provide, by the computing system, each respective node with each respective node feature to a machine learning model;
determine, by the computing system using the machine learning model, a subset of nodes of the plurality of nodes based at least in part on the respective node features; and
calculate, by the computing system, one or more solutions to the multi-node problem based at least in part on the subset of nodes;
store, by the computing system, the one or more solutions to the multi-node problem in a computer memory.

11. The system of claim 10, wherein the machine learning model includes an embedding module.

12. The system of claim 10, wherein the subset of nodes of the plurality of nodes comprises non-zero nodes.

13. The system of claim 10, wherein the multi-node problem represents a multi-echelon inventory optimization problem.

14. The system of claim 10, wherein calculating the one or more solutions to the multi-node problem comprises utilizing a guaranteed service model.

15. The system of claim 10, wherein the historical dataset comprises a plurality of solutions to multi-node problems.

16. A non-transitory computer-readable storage medium storing a set of instructions that, when executed by one or more processors of a computer system, cause the computer system to perform operations comprising:
accessing, by a computing system, a multi-node problem comprising a plurality of nodes, each respective node having one or more node features;
providing, by the computing system, each respective node with each respective node feature to a machine learning model;
determining, by the computing system using the machine learning model, a subset of nodes of the plurality of nodes based at least in part on the respective node features; and
calculating, by the computing system, one or more solutions to the multi-node problem based at least in part on the subset of nodes;
storing, by the computing system, the one or more solutions to the multi-node problem in a computer memory.

17. The non-transitory computer-readable storage medium of claim 16, wherein the subset of nodes of the plurality of nodes comprises non-zero nodes.

18. The non-transitory computer-readable storage medium of claim 16, wherein determining the subset of nodes further comprises:
determining, by the computing system using the machine learning model, a minimum value associated with each of the plurality of nodes;
determining, by the computing system using the machine learning model, a probability that the minimum value associated with each of the plurality of nodes is a value associated with each node in an optimal solution; and
identifying, by the computing system, the subset of nodes, each node of the subset of nodes identified as non-zero and characterized by a probability greater than or equal to a predetermined threshold.

19. The non-transitory computer-readable storage medium of claim 16, wherein calculating the one or more solutions to the multi-node problem and calculating the one or more updated solutions comprises utilizing a guaranteed service model.

20. The non-transitory computer-readable storage medium of claim 16, wherein the machine learning model includes an embedding module.
